(19) United States
(12) Patent Application Publication
(10) Pub. No.: US 2018/0046298 A1
(43) Pub. Date: Feb. 15, 2018

(54) TOUCH DISPLAY PANEL

(71) Applicant: HON HAI PRECISION INDUSTRY CO., LTD., New Taipei (TW)

(72) Inventors: YU-FU WENG, New Taipei (TW); CHIEN-WEN LIN, New Taipei (TW); CHIA-LIN LIU, New Taipei (TW)

(21) Appl. No.: 15/674,627

(22) Filed: Aug. 11, 2017

Related U.S. Application Data
(60) Provisional application No. 62/374,103, filed on Aug. 12, 2016.

(51) Int. Cl. G06F 3/041; G02F 1/1333; G02F 1/1368; G02F 1/1339; G02F 1/1335; G06F 3/044; G02F 1/1343

(52) U.S. Cl. CPC G06F 3/0412; G06F 3/044; G02F 1/13338; G02F 1/134336; G02F 1/13439; G02F 1/13394; G02F 1/133514; G02F 1/1368; G02F 1/133512; G06F 2203/04112; G06F 2203/04105; G02F 2001/134372; G02F 1/134363; G02F 2001/13398

(57) ABSTRACT

A touch display device includes a color filter substrate, and a thin film transistor substrate facing the color filter substrate. The thin film transistor substrate includes a common electrode layer. A force sensing electrode layer is formed on the color filter substrate. The common electrode layer includes a plurality of common electrodes. The common electrodes function as electrodes of the touch display device for sensing a touch position. The common electrodes and the force sensing electrode layer cooperatively form capacitors for sensing a touch force, their capacitance varying as a result of the distance between them being reduced.

### FIELD

The subject matter herein generally relates to a touch display panel.

### BACKGROUND

An on-cell or in-cell type touch screen device can be manufactured by installing a touch device in a display device. Such a touch screen device can be used as an output device for displaying images while being used as an input device for receiving a touch of a user touching a specific area of a displayed image. However, the touch screen device cannot sense the amount of touch force/pressure applied to the touch screen.

### BRIEF DESCRIPTION OF THE DRAWINGS

Implementations of the present technology will now be described, by way of example only, with reference to the attached figures.

FIG. 1 is an isometric view of an exemplary embodiment of a touch display device.

FIG. 2 is a cross-sectional view of a first exemplary embodiment of the touch display device of FIG. 1.

FIG. 3 is a planar view showing a force sensing electrode layer of the touch display device of FIG. 1.

FIG. 4 is a cross-sectional view of a second exemplary embodiment of the touch display device of FIG. 1.

FIG. 5 is a planar view of a color filter substrate of the touch display device of FIG. 4.

FIG. 6 is a cross-sectional view of a third exemplary embodiment of the touch display device of FIG. 1.

FIG. 7 a planar view of a color filter substrate of the touch display device of FIG. 6.

FIG. 8 is a cross-sectional view of a fourth exemplary embodiment of the touch display device of FIG. 1.

FIG. 9 is a cross-sectional view of a fifth exemplary embodiment of a display device.

FIGS. 10 through 12 are diagrammatic views of three types of driving time sequences of a touch display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series, and the like.

The touch display panel in the present disclosure can be used in a portable electronic device, such as a mobile phone, a watch, a tablet PC, a personal digital assistant (PDA), or the like, and can also be applied in a notebook computer, a television, and an electronic display screen. The touch display panel in the present disclosure may be a liquid crystal display (LCD) panel, such as a planar switching (IPS) type LCD panel, an edge field switching (FFS) type LCD panel, or the like.

The touch display panel in the present disclosure can sense positions and amount of the touch force applied thereon. The touch display panel includes a display module, a touch sensing module, and a force sensing module, wherein the touch sensing module and the force sensing module are integrated into the display module.

The display module includes a thin film transistor (TFT) substrate and a color filter (CF) substrate facing the TFT substrate, and the TFT substrate is provided with a common electrode layer.

The common electrode layer is supplied with common voltages for display, and the common electrode layer and pixel electrodes cooperatively form an electrical field to rotate liquid crystal molecules; the common electrode layer also functions as touch electrode for detecting touch position.

The force sensing module includes a sensing electrode layer. The sensing electrode layer is arranged on the color filter substrate. The sensing electrode layer and the common electrode layer may cooperatively form capacitors for sensing touch force. A distance between the common electrode layer and the sensing electrode layer decreases when a touch is applying on the touch display panel, and capacitances of the capacitors varies, then amount of the touch force can be calculated according to capacitance variations of the capacitors.

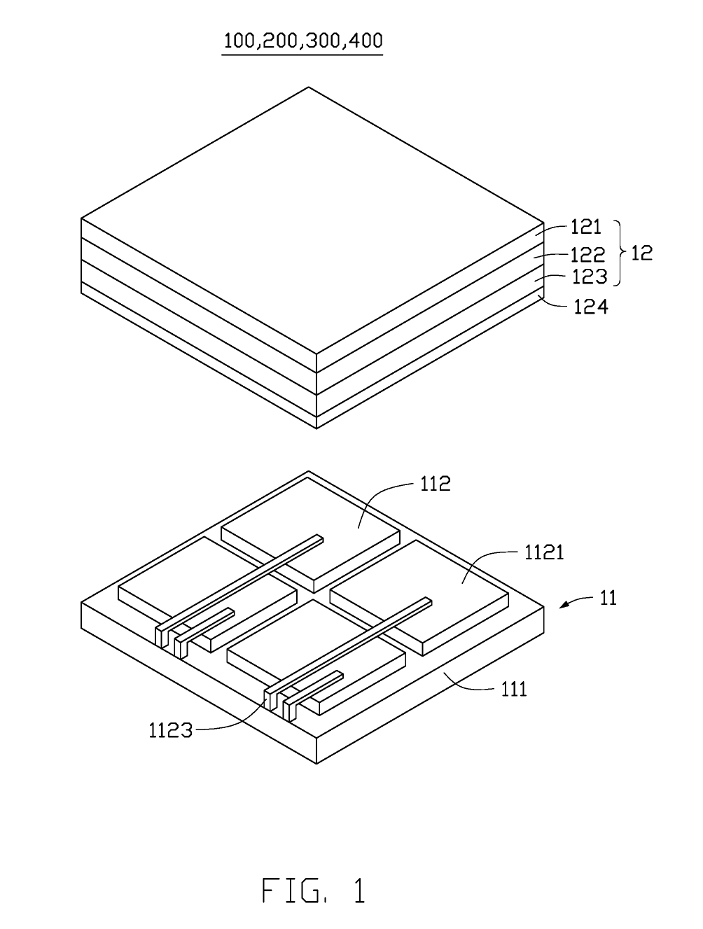

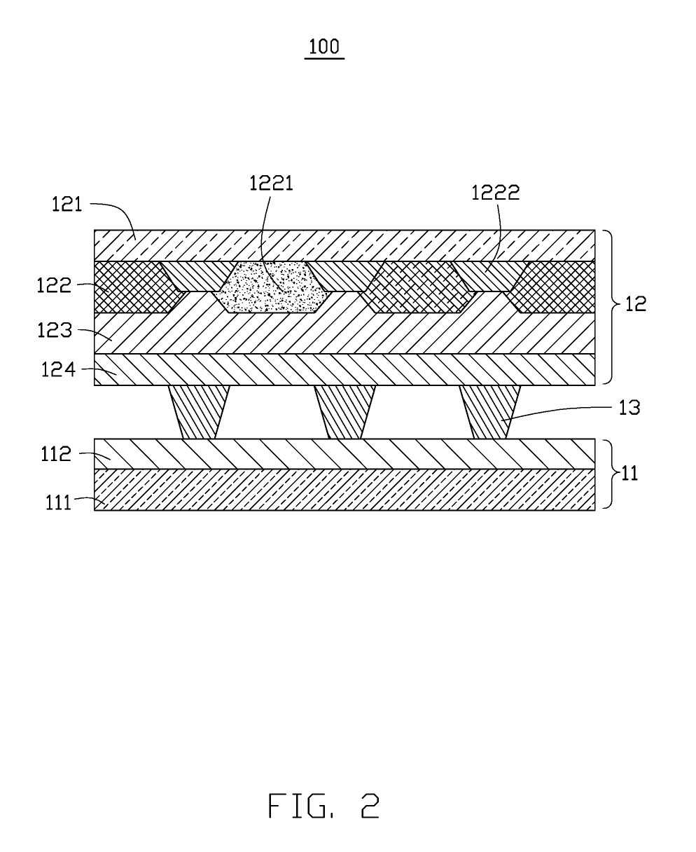

FIG. 1 and FIG. 2 illustrate a touch display panel 100 according to a first exemplary embodiment. The touch display panel 100 includes a display module. The display module includes a TFT substrate 11, a color filter substrate 12 facing the TFT substrate 11, and a liquid crystal layer (not explicitly shown) between the TFT substrate 11 and the color filter substrate 12. As shown in FIG. 2, a plurality of photo spacers 13 are located between the TFT substrate 11 and the color filter substrate 12 to maintain a distance between the TFT substrate 11 and the color filter substrate 12. It is understood that the touch display panel 100 may further includes a backlight module (not shown), a first polarizer (not shown), a second polarizer (not shown), and other necessary components (not shown) for functioning of a liquid crystal display device.

As shown in FIG. 1 and FIG. 2, the TFT substrate 11 includes a first substrate 111 and a common electrode layer 112 formed on a surface of the first substrate 111 adjacent the color filter substrate 12. It is to be understood that the TFT array substrate 11 further includes conventional elements of a liquid crystal display device, such as a plurality of TFTs (not shown), insulating layers (not shown), pixel electrodes (not shown), scanning lines (not shown), and data lines (not shown).

The first substrate 111 is configured to support the other elements (e.g. TFTs, pixel electrodes, and common electrode layer 112) of the TFT substrate 11. The first substrate 111 is transparent. For example, the first substrate 111 may be made of a transparent glass, a transparent plastic, or the like.

The common electrode layer 112 supplies common voltages for display and the common electrode layer 112 and pixel electrodes (not shown) cooperatively form electrical fields to rotate liquid crystal molecules. The common electrode layer 112 also functions as electrodes for detecting touch position. That is, the touch sensing module of the touch display device 100 includes the common electrode layer 112.

In the present exemplary embodiment, the common electrodes 1121 are made of a transparent conductive material, such as indium tin oxide (ITO). As shown in FIG. 1, the common electrode layer 112 is a patterned conductive layer and includes a plurality of common electrodes 1121 arranged in a matrix. Each common electrode 1121 may be electrically connected to a driving IC (not shown) through a trace 1123. The driving IC is configured to supply driving signals to the common electrodes 1121. In other embodiments, the common electrode 1121 may also be a sheet-like electrode. When the touch display panel 100 is used in a planar switching (IPS) type LCD device, each common electrode 1121 may have shape or formation of a comb (not shown).

A force sensing electrode layer 124 is formed on a surface of the color filter substrate 12 adjacent to the TFT substrate 11. In the present exemplary embodiment, the color filter substrate 12 includes a second substrate 121, a color filter layer 122 on a surface of the second substrate 121 adjacent to the TFT substrate 11, and a planar layer 123 on a surface of the color filter layer 122 adjacent to the TFT substrate 11. The force sensing electrode layer 124 is formed on a surface of the planar layer 123 adjacent to the TFT substrate 11.

The second substrate 121 is configured to support the other elements (e.g. color filter layer 122, the planar layer 123, and the force sensing electrode layer 124) of the color filter substrate 12. The second substrate 121 is transparent. For example, the second substrate 121 may be made of a transparent glass, a transparent plastic, or the like.

The color filter layer 122 is configured for converting the light emitted from the backlight module into red, green, and blue light for display. The color filter layer 122 includes a plurality of color filter units 1221 spaced apart from each other, and a black matrix layer 1222. Each color filter unit 1221 may be a red (R) color filter unit 1221, a green (G) color filter unit 1221, or a blue (B) color filter unit 1221. The black matrix 1222 is between any two adjacent color filter units 1221. In the present exemplary embodiment, the black matrix 1222 is made of a black resin material.

The planar layer 123 is an electrically insulating layer to cover the color filter layer 122, and to flatten the surface of the color filter substrate 12 adjacent to the liquid crystal layer.

During each force sensing period of the touch display device 100, the force sensing electrode layer 124, the common electrode layer 112, and the photo spacers 13 cooperatively form a plurality of capacitors for sensing touch forces. The force sensing module of the touch display device 100 includes a force sensing electrode layer 124, the common electrode layer 112, and the photo spacers 13. The photo spacers 13 are located between the force sensing electrode layer 124 and the common electrode layer 112. In the exemplary embodiments, the height of the photo spacers 13 has a relationship with a distance between the force sensing electrode layer 124 and the common electrode layer 112. Each photo spacer 13 is made of an elastic dielectric material. When a touch force is applied on the touch display device 100, the photo spacers 13 at the touch position may deform, and a distance between the force sensing electrode layer 124 and the common electrode layer 112 may vary, to vary capacitances of the capacitors. Thus, touch force can be calculated according to capacitance variations of the capacitors.

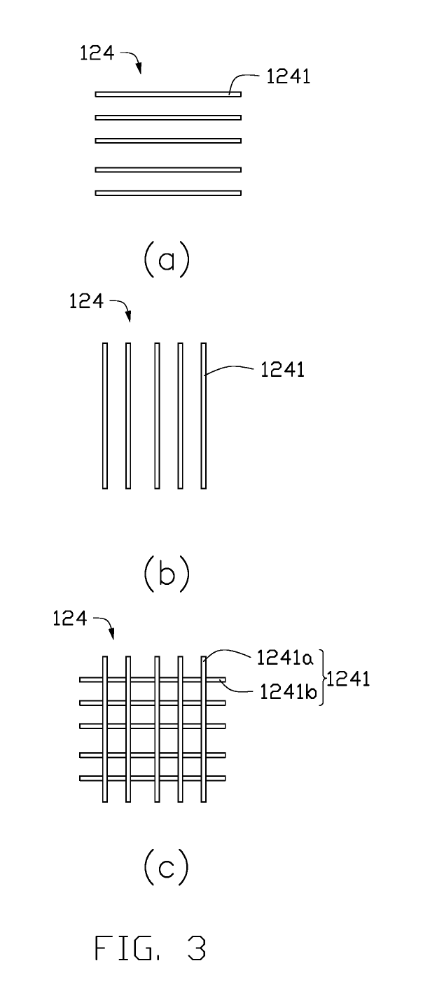

The force sensing electrode layer 124 is a patterned conductive layer. In this exemplary embodiment, the force sensing electrode layer 124 is made of a transparent conductive material, such as ITO. As shown in FIG. 3(a) and FIG. 3(b), the force sensing electrode layer 124 may includes a plurality of force sensing electrodes 1241 spaced apart from each other; and each force sensing electrode 1241 extends as a line along a same direction. Alternatively, the force sensing electrode layer 124 may have a mesh shape, as shown in FIG. 3(c). The force sensing electrode layer 124 includes a plurality of first portions 1241a and a plurality of second portions 1241b crossing with the first portions 1241a. Each first portion 1241a extends as a line along a same first direction; each second portion 1241b extends as a line along a same second direction, the first direction is different from the second direction. As shown in FIG. 3(c), the first direction is perpendicular to the second direction.

It is understood that a distance between every two force sensing electrodes 1241 as shown in FIG. 3(a) and FIG. 3(b) is sufficiently large such that electrical signals generated by a conductor (e.g., a finger of a user) touching the touch display device 100 can be transmitted to the common electrodes 1121 below the force sensing electrodes 1241. Thus, electrical signals of the common electrodes 1121 are affected so that the touch position can be sensed. It is understood that a distance between every adjacent two first portions 1241a and a distance between every adjacent two second portions 1241b shown in FIG. 3(c) is sufficiently large such that electrical signals generated by a conductor (e.g., a finger of a user) touching on the touch display device 100 can be transmitted to the common electrodes 1121 below the force sensing electrode layer 124, and can affect electrical signals of the common electrodes 1121 so that the touch position can be sensed.

The touch display panel 100 drives the display module, the touch sensing module, and the force sensing module by a time division driving method. A single time frame of the touch display panel 100 may be divided into a display period, a touch sensing period, and a touch force sensing period. During the display period, the common electrodes 1121 and pixel electrodes (not shown) cooperatively form an electrical field to rotate liquid crystal molecules. During the touch sensing period, the common electrodes 1121 function as a self-capacitive touch sensor; when finger is touching the touch display panel 100, the fingers as a conductor affect electrical signals of the common electrodes 1121 corresponding to the touch position, thus touch position can be detected. During the touch force sensing period, the plurality of common electrodes 1121 and the force sensing electrode layer 124 form a plurality of capacitive force sensors. In the present exemplary embodiment, each common electrode 1121 is a block electrode, and the force sensing electrode 1241 is a strip electrode. The common electrodes 1121 and the force sensing electrode layer 124 cooperatively form a plurality of capacitors. Specifically, during the touch force sensing period, a constant voltage (e.g. 1V, −1V, etc.) is provided to the force sensing electrode layer 124, or the force sensing electrode layer 124 is grounded. Until the touch display panel 100 is not touched, a distance D is between the common electrodes 1121 and force sensing electrode layer 124, and the capacitor formed between the common electrode 1121 and the force sensing electrode layer 124 has a capacitance C. When the touch display panel 100 is touched, the capacitance C varies with the variation of the distance D, thus amount of the touch force can be calculated according to capacitance variation of the capacitor formed between the common electrode 1121 and the force sensing electrode layer 124.

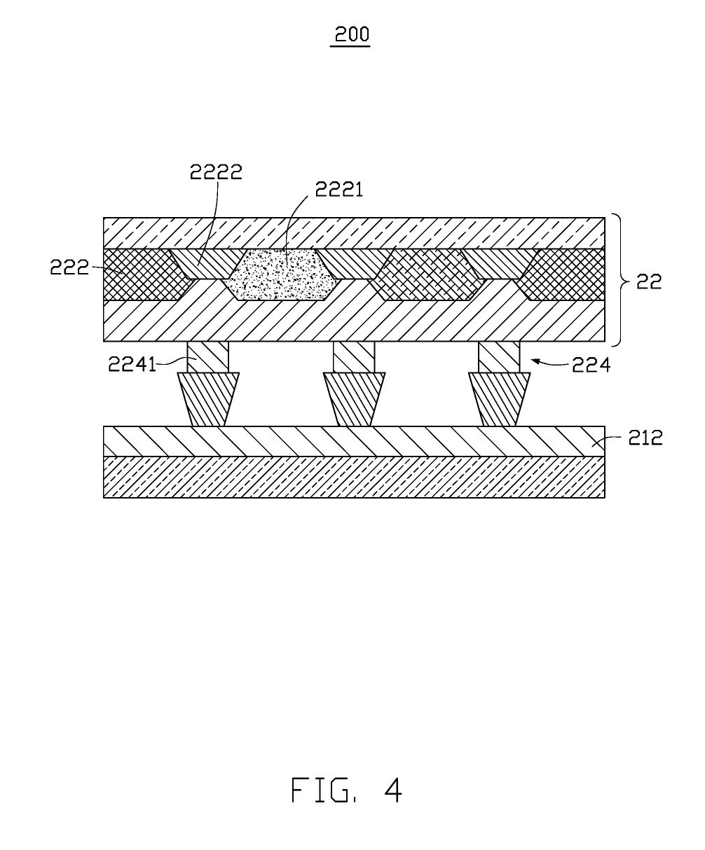

FIG. 4 illustrates a touch display device 200 according to a second exemplary embodiment. The touch display device 200 is substantially the same as the touch display device 100 of the first exemplary embodiment, except that touch display device 200 includes a force sensing electrode layer 224 that is made of a non-transparent conductive material, such as a conductive metal or a conductive alloy. The force sensing electrode layer 124 of the touch display device 100 is made of a transparent conductive material.

As shown in FIG. 4, the color filter layer 222 of the touch display device 200 also includes a plurality of color filter units 2221 spaced apart from each other and a black matrix layer 2222. The force sensing electrode layer 224 is located below the black matrix layer 2222 and is completely covered by the black matrix layer 2222, thus the force sensing electrode layer 224 has no effect on an aperture ratio of the touch display device 200.

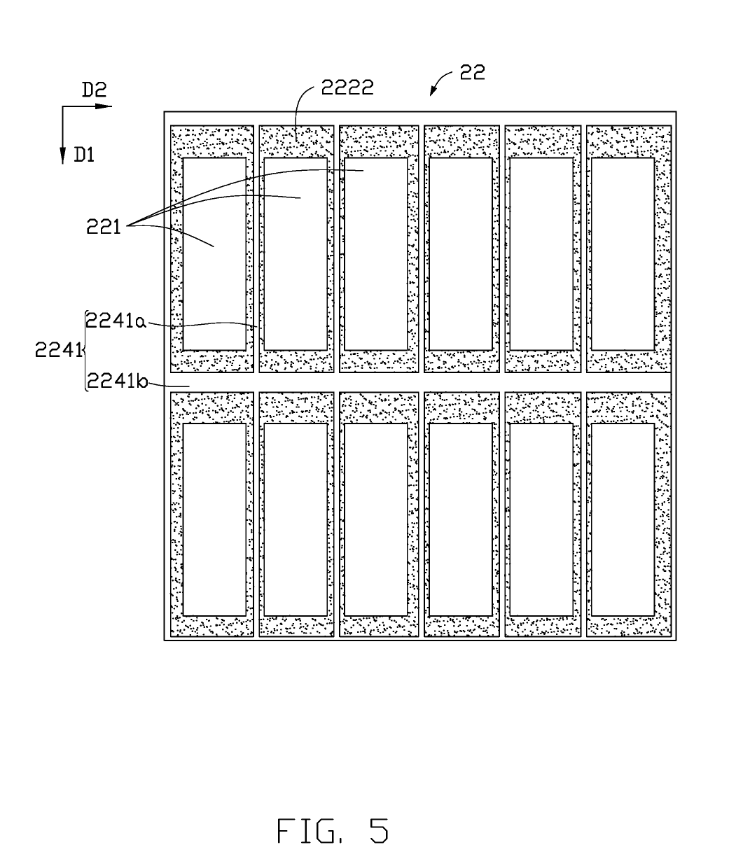

FIG. 5 is a planar view of a color filter substrate 22 of the touch display device 200 viewed from a side of the color filter substrate 22 having the force sensing electrode layer 224. As shown in FIG. 5, the black matrix layer 2222 is located in regions between any two adjacent color filter units 2221. As shown in FIG. 5, the force sensing electrode layer 224 may have a mesh shape. The force sensing electrode layer 224 includes a plurality of first portions 2241a and a plurality of second portions 2241b crossing with the first portions 2241a. Each first portion 2241a extends as a line along a same first direction D1 and each second portion 2241b extends as a line along a same second direction D2. The first direction D1 is different from the second direction D2. In the exemplary embodiment, the first direction D1 is perpendicular to the second direction D2.

As shown in FIG. 5, the force sensing electrode layer 224 overlaps with the black matrix layer 2222. Each first portion 2241a is between two adjacent color filter units 2221 along the second direction D2 and has a width that is less than a width of the black matrix layer 2222 between the two adjacent color filter units 2221. Each second portion 2241b is between two adjacent color filter units 2221 along the first direction D1 and has a width that is less than a width of the black matrix layer 2222 between the two adjacent color filter units 2221.

When the touch display device 200 is touched by a conductor (e. g. a finger), the force sensing electrode layer 224 is a conductive component between the conductor (e. g. a finger) and the common electrode layer 212, thus the force sensing electrode layer 224 may affect an electrical field between the conductor (e. g. a finger) and the common electrode layer 212, thus affect touch sensing results. Therefore, it is necessary to reduce an area size of the force sensing electrode layer 224 to reduce its effect on the touch sensing. In the exemplary embodiment, the force sensing electrode layer 224 is designed to have a mesh shape as shown in FIG. 5 or FIG. 3(c) to reduce its area size. In other embodiments, the force sensing electrode layer 224 may also be designed to have a plurality of force sensing electrodes parallel to each other as shown in FIG. 3(a) and FIG. 3(b). Each force sensing electrode has a line shape and each force sensing electrode may be between two adjacent color filter units 2221 and has a width that is less than a width of the black matrix layer 2222 between the two adjacent color filter units 2221.

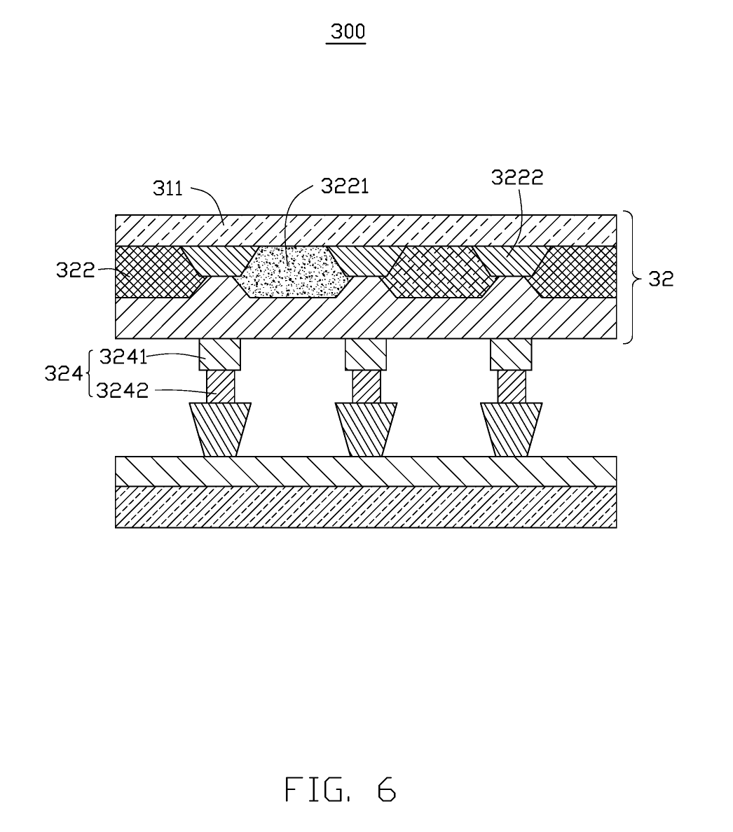

FIG. 6 illustrates a touch display device 300 according to a third exemplary embodiment. The touch display device 300 is substantially the same as the touch display device 200 of the second exemplary embodiment, except that the force sensing electrode layer 324 of the touch display device 300 includes not only a conductive metal layer 3242 but also a transparent conductive layer 3241 stacked on the conductive metal layer 3242. Herein, the transparent conductive layer 3241 is more adjacent to the second substrate 321 compared with conductive metal layer 3242. The conductive metal layer 3242 is also located below the black matrix layer 3222 and completely covered by the black matrix layer 3222, thus the force sensing electrode layer 324 has no effect on an aperture ratio of the touch display device 300.

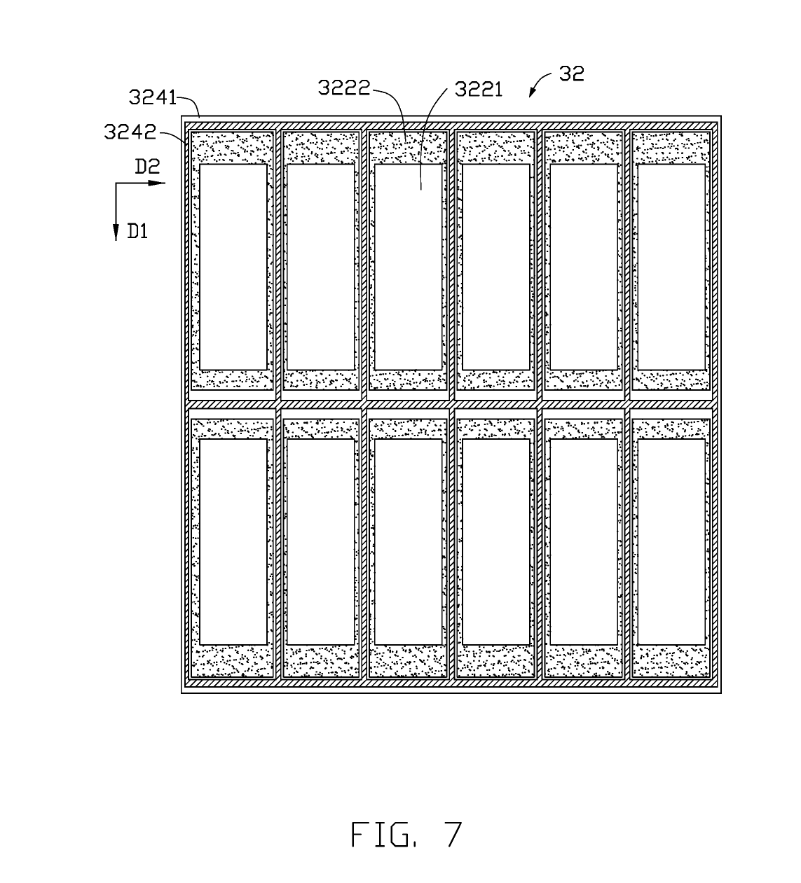

FIG. 7 is a planar view of a color filter substrate of the touch display device 300 viewed from a side of the color filter substrate 32 having the force sensing electrode layer 324. As shown in FIG. 7, the black matrix layer 3222 is located in regions between any two adjacent color filter units 3221. As shown in FIG. 7, the conductive metal layer 3242 and the transparent conductive layer 3241 may have a mesh shape. The conductive metal layer 3242 between any two adjacent color filter units 3221 has a width that is less than a width of the transparent conductive layer 3241 between the two adjacent color filter units 3221.

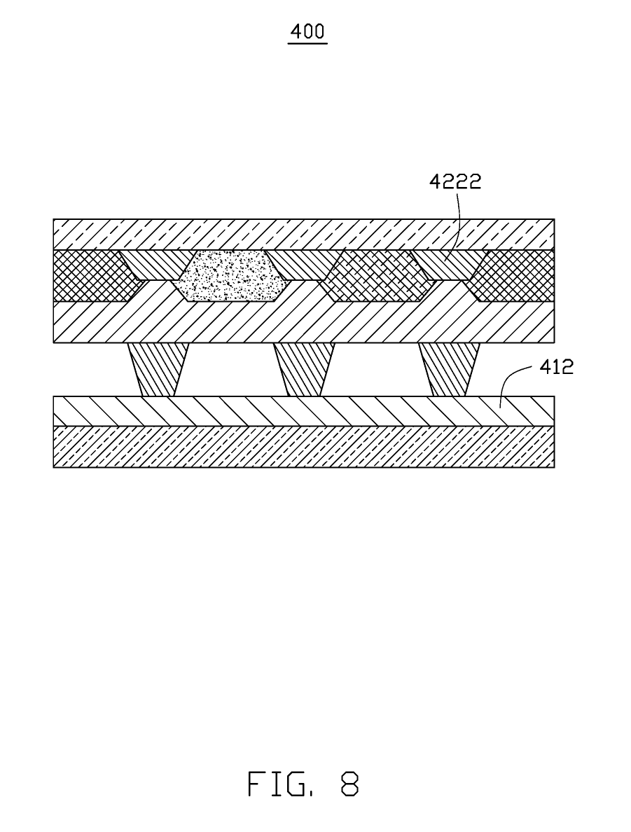

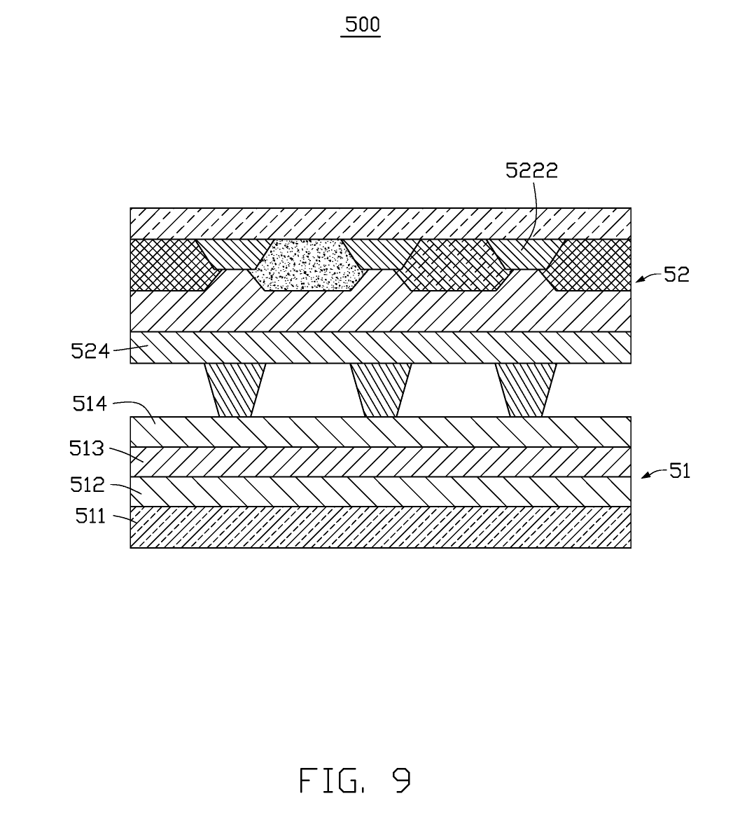

FIG. 8 illustrates a touch display device 400 according to a fourth exemplary embodiment. The touch display device 400 is substantially the same as the touch display device 100 of the first exemplary embodiment, except that the touch display device 400 includes no additional force sensing electrode layer 324; and the black matrix layer 4222 of the touch display device 400 is made of a conductive metal or a conductive alloy, and the black matrix layer 4222 functions as a force sensing electrode layer. During the touch force sensing period, the common electrode layer 412 and the black matrix layer 4222 form a plurality of capacitors for sensing touch force.

FIG. 8 illustrates a touch display device 500 according to a fifth exemplary embodiment. The touch display device 500 includes a color filter substrate 52 that is substantially the same as the color filter substrate 12 of the touch display device 100 of the first exemplary embodiment, except that the touch display device 500 includes a TFT substrate 51 that is different from the TFT substrate 11 of the touch display device 100.

A first force sensing electrode layer 524 is formed on a surface of the color filter substrate 52 adjacent to the TFT substrate 51. The TFT substrate 51 includes a first substrate 511, a common electrode layer 512 on a side of the first substrate 111 adjacent to the color filter substrate 52, a second force sensing electrode layer 513 on a side of the common electrode layer 512 adjacent to the color filter substrate 52, and a pixel electrode layer 514 on a side of the second force sensing electrode layer 513 adjacent to the color filter substrate 52. It is understood that the common electrode layer 512, the second force sensing electrode layer 513, and the pixel electrode layer 514 are insulated from each other. That is, an insulating layer (not shown) is formed between the common electrode layer 512 and the second force sensing electrode layer 513. Another insulating layer (not shown) is formed between the second force sensing electrode layer 513 and the pixel electrode layer 514.

During the display period, the common electrode layer 512 and the pixel electrode layer 514 cooperatively form electrical fields to rotate liquid crystal molecules. During the touch sensing period, the second force sensing electrode layer 513 functions as a self-capacitive sensor for sensing touch position. During the touch force sensing period, the second force sensing electrode layer 513 and the first force sensing electrode layer 524 may form a plurality of capacitors for sensing touch force.

The present disclosure also provides a determination in a method for establishing whether or not capacitance variation of the force sensing module of the above-described touch display panel is caused by a user touch. The method may include the following steps.

Step S11: setting a threshold value of the capacitance variation ΔC of a force sensing module.

Step S12: measuring a capacitance value C of the force sensing module in a touched state, and calculating the capacitance variation ΔC according to the capacitance value C and a capacitance value C′ of the force sensing module when untouched.

Step S13: If the capacitance variation ΔC is equal to or greater than the threshold value, it is determined that there is a touch, and if the capacitance variation ΔC is less than the threshold value, it is determined that there is no touch.

In addition, since the dielectric constant £ of the liquid crystal may change with the variations of grayscale levels of the displaying image, and the dielectric constant £ of the liquid crystal has a large influence on the capacitance value C of the force sensing module. So the grayscale level of the displaying image may also affect the capacitance value C. Therefore, it is necessary to compensate for the capacitance variation caused by the variations of grayscale levels.

A compensating method for obtaining a capacitance value C′ of the force sensing module when untouched is provided herein. The compensating method may include the following steps.

S121: partitioning the common electrode layer 112 into several parts, and measuring capacitance values C′ corresponding to each part at different average grayscale levels when there is no touch. For example, each part may include at least one common electrode 1121 as shown in FIG. 1.

S123: constructing a grayscale level vs capacitance chart including capacitance values C′ corresponding to each part at different average grayscale levels when there is no touch.

S125: looking up the table to obtain the capacitance value C′ of the part according to the average grayscale level.

Thus, the capacitance variation ΔC can be calculated by subtracting the capacitance value C′ from the capacitance value C.

The following example shows details of a method of obtaining the capacitance variation ΔC and determining whether there is a touch on the touch display panel.

For example, the four common electrodes 1121 as shown in FIG. 1 may be represented by the numbers 1, 2, 3, and 4, respectively.

Table 1 is an example of a grayscale level vs capacitance chart.

TABLE 1

Condition
capacitance value C′ at different gray levels
(no touch)

| Sensor part | average gray level = 0 | average gray level = 255 |
|---|---|---|
| 1 | 20 | 200 |
| 2 | 10 | 190 |
| 3 | 15 | 180 |
| 4 | 5 | 195 |

For example, a threshold of ΔC is 100. As shown in Table 2, if ΔC is more than 100, a touch is deemed made on the panel. If ΔC is less than 100, no touch is deemed.

TABLE 2

| | | | ΔC | |
|---|---|---|---|---|
| | | | (Capacitance | Determine |
| Sensor | Current | Capacitance | after be | whether touch |
| patch | gray level | C1′ | compensated) | on panel |
| 1 | 255 | 200 | 0 | NO |
| 2 | 0 | 300 | 290 | YES |
| 3 | 255 | 250 | 70 | NO |
| 4 | 0 | 110 | 105 | YES |

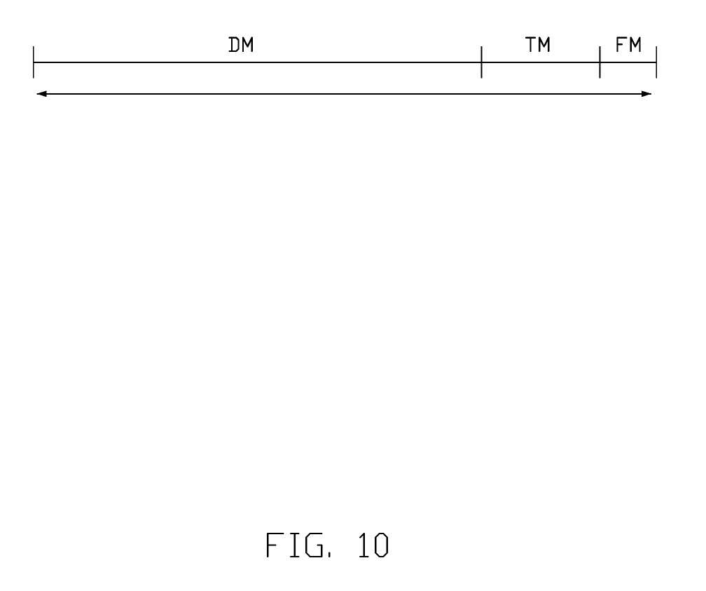

FIG. 10 through FIG. 12 show three different driving time sequences of the touch display devices 100, 200, 300, 400 of the first through the fourth exemplary embodiments. The touch display devices 100, 200, 300, 400 are driven by a time division driving method.

As shown in FIG. 10, one frame of time, or a single frame, is divided into a display period (DM), a touch sensing period (TM), and a touch force sensing period (FM). The driving circuit of the touch display device alternately drives the touch display device to display during the DM, to detect touch position during the TM, and to detect touch force during the FM in one frame time.

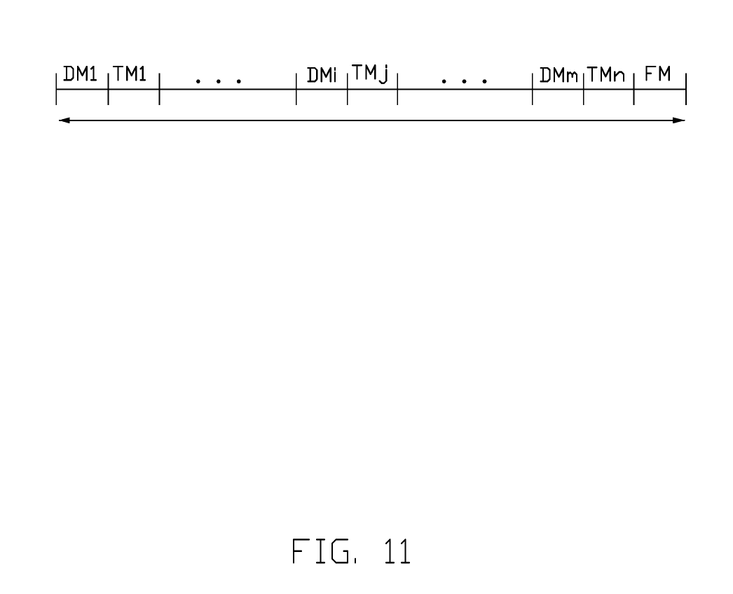

As shown in FIG. 11, one frame time, or a single frame, is divided into a plurality of display sub-periods (DM₁ through DMₙ), a plurality of touch sensing sub-periods (TM₁ through TMₙ), and a touch force sensing period (FM). The display sub-periods (DM₁ through DMₙ) and the touch sensing sub-periods (TM₁ through TMₙ) are alternating. The driving circuit of the touch display device alternately drives the touch display device to display during each display sub-period and to detect touch position during each touch sensing sub-period; and finally drives the touch display device to detect touch force during the FM, in one frame of time.

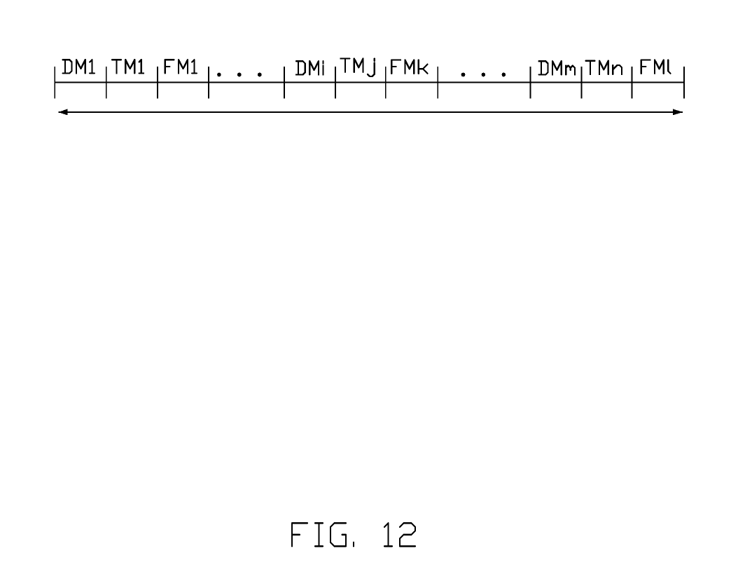

As shown in FIG. 12, one frame of time, or a single frame, is divided into a plurality of display sub-periods (DM₁ through DMₙ), a plurality of touch sensing sub-periods (TM₁ through TMₙ), and a plurality of touch force sensing sub-periods (FM₁ through FMₙ). The display sub-periods (DM₁ through DMₙ), the touch sensing sub-periods (TM₁ through TMₙ), and the touch force sensing sub-periods (FM₁ through FMₙ) are alternating. The driving circuit of the touch display device alternately drives the touch display device to display during each display sub-period, to detect touch position during each touch sensing sub-period, and to detect touch force during each touch force sensing sub-period in one frame of time.

During the display period or the display sub-periods, for the touch display devices 100, 200, 300, 400, each common electrode may be supplied with a common voltage, each pixel electrode may be applied with a voltage different from the common voltage, and the force sensing electrode layer may be electrically floating.

During the touch sensing period or the touch sensing sub-period, for the touch display devices 100, 200, 300, 400, each common electrode may be supplied with a voltage, each pixel electrode and the force sensing electrode layer may be floating.

During the force sensing period or the force sensing sub-periods, for the touch display devices 100, 200, 300, 400, each common electrode may be supplied with a voltage, the force sensing electrode layer may be may be electrically grounded, and each pixel electrode may be floating.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A touch display device comprising:
a color filter substrate;
a thin film transistor substrate facing the color filter substrate, the thin film transistor substrate comprising a common electrode layer; and
a force sensing electrode layer formed on the color filter substrate,
wherein the common electrode layer comprises a plurality of common electrodes; the plurality of common electrodes functions as electrodes of the touch display device for sensing a touch position; the plurality of common electrodes and the force sensing electrode layer cooperatively form capacitors for sensing a touch force.

2. The touch display device of claim 1, wherein the plurality of common electrodes are made of a transparent conductive material and arranged in a matrix.

3. The touch display device of claim 1, wherein a plurality of photo spacers are located between the thin film transistor substrate and the color filter substrate to keep a distance between the thin film transistor substrate and the color filter substrate; each of the plurality of photo spacers is made of an elastic dielectric material.

4. The touch display device of claim 1, wherein the force sensing electrode layer is formed on a surface of the color filter substrate adjacent to the thin film transistor substrate.

5. The touch display device of claim 4, wherein the color filter substrate comprises a substrate, a color filter layer formed on a surface of the substrate adjacent to the thin film transistor substrate, and a planar layer formed on a surface of the color filter layer adjacent to the thin film transistor substrate; the force sensing electrode layer is formed on a surface of the planar layer adjacent to the thin film transistor substrate.

6. The touch display device of claim 5, wherein the force sensing electrode layer is made of a transparent conductive material.

7. The touch display device of claim 5, wherein the force sensing electrode layer is made of a conductive metal or a conductive alloy; the color filter layer comprises a plurality of color filter units spaced apart from each other and a black matrix layer in regions between any two adjacent color filter units; the force sensing electrode layer locates below the black matrix layer and is completely covered by the black matrix layer.

8. The touch display device of claim 7, wherein the force sensing electrode layer comprises a plurality of force sensing electrodes spaced apart from each other; each of the plurality of force sensing electrodes extends as a line along a same direction; each of the plurality of force sensing electrodes is between two adjacent color filter units and has a width that is less than a width of the black matrix layer between the two adjacent color filter units.

9. The touch display device of claim 7, wherein the force sensing electrode layer have a mesh shape; the force sensing electrode layer comprises a plurality of first portions spaced apart from each other and a plurality of second portions spaced apart from each other; the plurality of first portions cross with the plurality of second portions; each of the plurality of first portions extends as a line along a first direction; each of the plurality of second portions extends as a line along a second direction, the first direction is different from the second direction; each of the plurality of first portions is between two adjacent color filter units along the second direction and has a width that is less than a width of the black matrix layer between the two adjacent color filter units; and each of the plurality of second portions is between two adjacent color filter units along the first direction and has a width that is less than a width of the black matrix layer between the two adjacent color filter units.

10. The touch display device of claim 5, wherein the force sensing electrode layer comprises a conductive metal layer and a transparent conductive layer stacked on the conductive metal layer, wherein the transparent conductive layer is more adjacent to the color filter substrate compared with the conductive metal layer.

11. The touch display device of claim 10, wherein the color filter layer comprises a plurality of color filter units spaced apart from each other and a black matrix layer in regions between any two adjacent color filter units; the conductive metal layer is completely covered by the black matrix layer.

12. The touch display device of claim 1, wherein the color filter substrate comprises a substrate and a color filter layer formed on a surface of the substrate adjacent to the thin film transistor substrate; the color filter layer comprises a plurality of color filter units spaced apart from each other; the force sensing electrode layer function as a black matrix layer and is in regions between any two adjacent color filter units.

13. The touch display device of claim 1, wherein the force sensing electrode layer comprises a plurality of force sensing electrodes spaced apart from each other; each of the plurality of force sensing electrodes extends as a line along a same direction.

14. The touch display device of claim 1, wherein the force sensing electrode layer have a mesh shape; the force sensing electrode layer comprises a plurality of first portions spaced apart from each other and a plurality of second portions spaced apart from each other; the plurality of first portions cross with the plurality of second portions; each of the plurality of first portions extends as a line along a same first direction; each of the plurality of second portions extends as a line along a same second direction, the first direction is different from the second direction.

15. A touch display device comprising:
a color filter substrate;
a thin film transistor substrate facing the color filter substrate; and
a first force sensing electrode layer formed on the color filter substrate,
wherein the thin film transistor substrate comprises a substrate, a common electrode layer on a side of the substrate adjacent to the color filter substrate, a second force sensing electrode layer on a side of the common electrode layer adjacent to the color filter substrate, and a pixel electrode layer on a side of the second force sensing electrode layer adjacent to the color filter substrate; the common electrode layer, the second force sensing electrode layer, and the pixel electrode layer are electrically insulated from each other; the second force sensing electrode layer function as a self-capacitive sensor for sensing touch position; the second force sensing electrode layer and the first force sensing electrode layer cooperatively form capacitors for sensing a touch force.
